(19) United States
(12) Patent Application Publication
(10) Pub. No.: US 2005/0057700 A1
(43) Pub. Date: Mar. 17, 2005

(54) Digital cable capable of improving a reception performance for an additional signal in an out-of-band channel and a method of receiving thereof

(76) Inventors: Sang-min Lim, Seoul (KR); Young-ho Choi, Suwon-si (KR)

Correspondence Address: STANZIONE & KIM, LLP, 1740 N STREET, N.W., FIRST FLOOR, WASHINGTON, DC, 20036, US

(21) Appl. No.: 10/934,499

(22) Filed: Sep. 7, 2004

(30) Foreign Application Priority Data
Sep. 12, 2003 (KR) 2003-88874

(51) Int. Cl. H04N 7/173; H04N 5/44; H04B 1/18; H04N 7/16

(52) U.S. Cl. 348/734; 725/127; 725/131; 725/139; 725/151; 455/188.1; 455/192.3; 455/189.1

(57) ABSTRACT

A digital cable receiver capable of improving reception performance of an additional signal in an out-of-band channel and a method of receiving the additional signal. The digital cable receiver can include an out-of-band filter to output the out-of-band channel, a band splitting unit to split the out-of-band channel into a predetermined number of frequency bands, a band selection unit to select a frequency band carrying the additional signal out of the split predetermined number of frequency band, a down-converter to down convert the additional signal in the selected frequency band into a predetermined intermediate frequency signal, and a control unit to control the band selection unit and the down-converter in cooperation with the cable card. Accordingly, the digital cable receiver can selectively pass only the frequency band carrying the additional signal out of the out of band channel using the information on the frequency band carrying the additional signal in the out-of-band channel obtained by cooperating with the cable card and can down-convert the selected frequency band, thereby eliminating interference with other channels adjacent to the additional signal.

### CROSS-REFERENCE TO RELATED APPLICATIONS

This application claims benefit under 35 U.S.C. § 119 from Korean Patent Application No. 2003-88874, filed on Dec. 9, 2003, the entire contents of which are incorporated herein in its entirety.

### BACKGROUND OF THE INVENTION

1. Field of the Invention

The present general inventive concept relates generally to a digital cable broadcasting receiver, and more particularly, to a digital cable broadcasting receiver capable of improving the reception performance of an additional signal in an out-of-band channel and a method of receiving the additional signal.

2. Description of the Related Art

In general, the first generation cable TV began with business designed for transmitting TV broadcasting to homes in areas out of service to which ground wave broadcasting may not propagate well. The second generation cable TV developed into a multi-channel broadcasting business that expanded subscriber's households for even wider city areas. In the next generation, the cable TV is changing into digital broadcasting business for an integral provision of communication service and broadcasting. In order to meet the tendency of the times, recently, OpenCable™ system of cable TV standard system that has been established by ‘CableLabs’ in USA has been determined as the domestic digital cable TV standard, and the search and development for settling it is in progress.

The digital cable broadcasting system can be mainly classified into a head-end, a digital cable receiver (set-top box), and a security module. The digital cable receiver performs the signal processing for a digital cable signal that is transmitted from the head end in cooperation with the security module mounted thereon.

The digital cable signal sent from the head-end includes audio/video signals within an in-band channel and an additional signal in an out-of-band channel. Hence, the digital cable receiver has a path for processing the audio/video signals in the in-band channel and a path for processing the additional signal in the out-of-band channel. The additional signal includes the information on program and data for the control and access between the head-end and the receiver.

The security module mounted on the receiver incorporates the operation to process the additional signal in out-of-band and a Conditional Access System (CAS) operation. Furthermore, the security module includes the function for descrambling the scrambled audio/video signals in cooperation with the head-end.

FIG. 1 is a block diagram of a conventional digital cable receiver which receives an additional signal in an out-of-band channel.

The additional signal from the head-end is transmitted via the out-of-band channel. For example, it is assumed that the additional signal having a 1 MHz or 2 MHz frequency band is transmitted while being carried on a specific frequency 75.25 MHz in the out-of-band channel region of 70 MHz˜130 MHz.

The digital cable receiver includes a tuner 11, an out-of-band filter 13, a down-converter 15, an interface unit 17, a channel decoder 19, and a control unit 21. The digital cable receiver incorporates a cable card 10 being a security module mounted thereon.

The out-of-band filter 13 passes only signals in the out-of-band channel region of 70 MHz˜130 MHz out of the digital cable signals received from the tuner 11. The down-converter 15 generates a predetermined local oscillator frequency (LO Freq.) based on the control signal of the channel decoder 19, and mixes the signal in the out-of-band channel region of 70 MHz˜130 MHz with the local oscillator frequency. Accordingly, the additional signal in the out-of-band channel is down-converted into a predetermined intermediate frequency signal of 44 MHz.

If the cable card 10 is mounted on the receiver, the control unit 21 recognizes the out-of-band information provided on the cable card 10 through the interface unit 17, and provides the recognized out-of-band information to the channel decoder 19. Hence, the out-of-band channel information is a position having the additional signal carried on the out-of-band channel region of 70 MHz˜130 MHz, that is, frequency information.

The channel decoder 19 decodes the out-of-band information in a predetermined manner and controls the down-converter 15 based on the decoded out-of-band information. For example, when the frequency has the additional signal carried being 75.25 MHz, in order for the frequency to be down-converted into the frequency of 44 MHz, the channel decoder 19 controls the down-converter 15 so that the down-converter 15 can generate the local oscillator frequency of 119.25 MHz. Next, the surrounding signals of the down-converted intermediate frequency signal are eliminated by a SAW filter (not shown) having a predetermined passband, and the intermediate frequency signal having the surrounding signals eliminated is input to the channel decoder 19 and is decoded. However, when the additional signal in the out-of-band channel is received by the prior art digital cable receiver described above, some problems arise which will be described below.

FIG. 2 illustrates the frequency spectrum in the out-of-band channel region of 70 MHz˜130 MHz that is filtered by the out-of-band filter 13 shown in FIG. 1. The additional signal a is sent from the head-end while being carried on the specific frequency in the out-of-band channel, and in the out-of-band channel, there are included analogue number 4 channel (67.25 MHz) and analogue number 6 channel (83.25 MHz), cable broadcasting number 14 channel (121.25 MHz), cable broadcasting number 15 channel (127.25 MHz), and cable broadcasting number 16 channel (133.25 MHz).

Accordingly, if the signal of the out-of-band channel passed through the out-of-band filter 13 is mixed with a predetermined local oscillator frequency to be down-converted, the reception performance of the additional signal is degraded due to the signal interference with adjacent channels.

### SUMMARY OF THE INVENTION

The present general inventive concept provides a solution to the above drawbacks and other problems associated with the conventional arrangement. Accordingly, an aspect of the present general inventive concept is to provide a digital cable receiver capable of improving the reception performance of an additional signal in an out-of-band channel and a method of receiving the additional signal.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a digital cable receiver on which a cable card having outer band information on an additional signal in an out-of-band channel in addition to a broadcasting signal is mounted, the digital cable receiver including an outer band filter to output an out-of-band channel from a received signal, a band splitting unit to split the output out-of-band channel into a predetermined number of frequency bands, a band selection unit to select a frequency band carrying the additional signal from one of the split predetermined number of frequency bands, a down-converter to down-convert the additional signal in the selected frequency band into a predetermined intermediate frequency signal, and a control unit to control the band selection unit and the down-converter in cooperation with the cable card.

The digital cable receiver can further include a channel decoder to decode the received signal in a predetermined manner. The channel decoder decodes the out-of-band information interfaced from the cable card, and provides the band selection unit and the down-converter with each of control signal based on the decoded out-of-band information.

The band splitting unit can include the predetermined number of band filters, and the cut-off frequency of each of the band filters is set so that a certain frequency band is overlapped with each other.

The foregoing and/or other aspects of the present general inventive concept can also be achieved by providing a method of receiving an additional signal of a digital cable receiver on which a cable card having out-of-band information on additional signal in an out-of-band channel in addition to a broadcasting signal is mounted, the method including the operations of splitting a passed out-of-band channel into a predetermined number of frequency bands, selecting a frequency band carrying the additional signal, out of the split predetermined number of frequency bands, and down-converting the additional signal in the selected frequency band into a predetermined intermediate frequency signal.

The method can further include decoding the out-of-band information interfaced from the cable card in a predetermined manner. The method controls the selecting and down-converting operations based on the decoded out-of-band information.

In the splitting operation, the out-of-band channel can be split into the predetermined number of frequency bands by a predetermined number of band filters, the cut-off frequency of each of the band filters can be set so that a certain frequency band is overlapped with each other.

Accordingly, the digital cable receiver of the present general inventive concept can selectively pass only the frequency band carrying the additional signal out of the out-of-band channel using the information on the frequency band carrying the additional signal in the out-of-band channel and down-convert the selected frequency band, thus eliminating the interference with other channels adjacent to the additional signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of the conventional digital cable receiver which receives additional signal in out-of-band channel;

FIG. 2 is a frequency spectrum for an out-of-band channel region of 70 MHz˜130 Mz that is filtered by the out-of-band filter 13 of FIG. 1;

FIG. 3 is a block diagram of the digital cable receiver which receives an additional signal in an out-of-band channel, according to an embodiment of the present general inventive concept;

FIG. 4 is a frequency spectrum for the out-of-band channel that is split into a predetermined number of frequency bands, according to an embodiment of the present general inventive concept; and

FIG. 5 is a flow chart illustrating exemplary operations to receive the additional signal in the out-of-band channel by the digital cable receiver, according to an embodiment of the present general inventive concept.

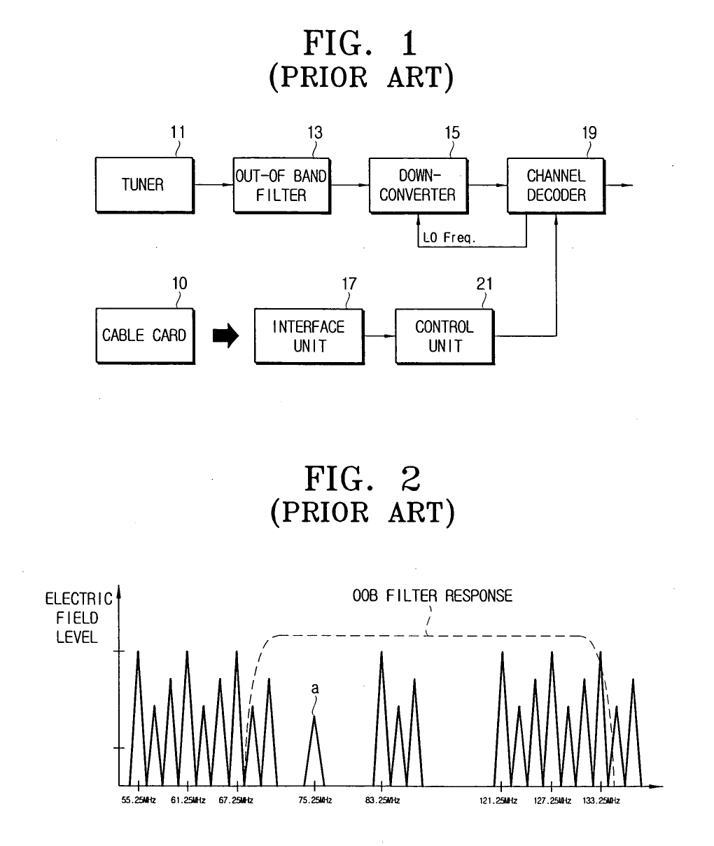

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

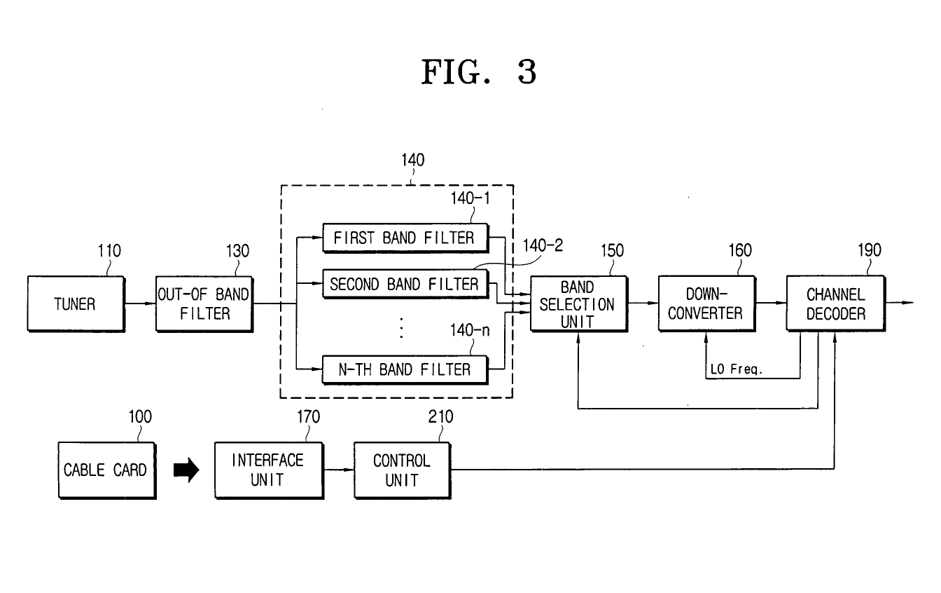

FIG. 3 is a block diagram of the digital cable receiver, according to an embodiment of the present general inventive concept, and schematically illustrates a head portion of the receiver that receives an additional signal in an out-of-band channel.

Referring now to FIG. 3, the digital cable receiver includes a tuner 110, an out-of-band filter (or outer band filter) 130, a band splitting unit 140, a band selection unit 150, a down-converter 160, an interface unit 170, a channel decoder 190, and a control unit 210. The digital cable receiver further includes a cable card 100 mounted thereon.

The tuner 110 can receive a digital cable signal that can be sent from a head-end.

The out-of-band filter 130 can pass only the out-of-band signal of the digital cable signals received from the tuner 110.

The band splitting unit 140 can split the out-of-band channel passed through the out-of-band filter 130 into a predetermined number of bands. The band splitting unit 140 splits the out-of-band channel into frequency bands of n using n band filters 140-1, 140-2, . . . 140-n. Each of the band filters 140-1, 140-2, . . . 140-n can be designed to overlap the cut-off frequency with each other. This is to extract the additional signal carried on the cut-off frequency of each of the band filters 140-1, 140-2, . . . 140-n.

The band selection unit 150 can select the frequency band carrying the additional signal by the control signal of the channel decoder 190, out of n frequency bands split by the band splitting unit 140. When the cable card 100 is mounted, the out-of-band information can be provided from the interface unit 170 to the control unit 210, and the control unit 210 transmits the interfaced out-of-band information to the channel decoder 190. The channel decoder 190 can decode the out-of-band information and controls the band selection unit 150 based on the out-of-band information. Accordingly, the band selection unit 150 selects the frequency band carrying the additional signal out of the n frequency bands on the basis of the control signal.

The down-converter 160 can generate a predetermined local oscillator frequency (LO Freq.) based on the control signal of the channel decoder 190, can mix the generated local oscillator frequency with the selected frequency band signal, and can then down-convert the additional signal included in the selected frequency band into a predetermined intermediate frequency signal. The channel decoder 190 can provide as a control signal the local oscillator frequency information to be mixed to the down-converter on the basis of the decoded out-of-band information. The channel decoder 190 can then eliminate the surrounding signals of the down-converted intermediate frequency signal by a given number of SAW filters (not shown).

The channel decoder 190 can decode the down-converted intermediate frequency signal (the additional signal) in a predetermined manner. As described above, the channel decoder 190 can decode the out-of-band information provided from the cable card 100 in a predetermined manner and can control the band selection unit 150 and the down-converter 160, respectively.

The control unit 210 can control general operations of the digital cable receiver, and can control the signal processing for video/audio signals and the additional signal in cooperation with the mounted cable card through the interface unit 170.

Accordingly, it is possible to prevent the signal interference with adjacent channels by selectively passing the frequency band carrying the additional signal out of the out-of-band signal to down-convert it.

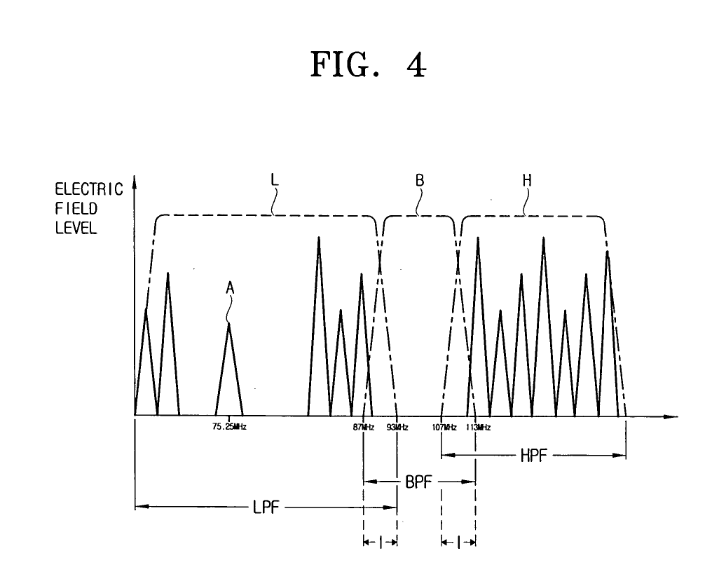

FIG. 4 is an exemplary frequency spectrum when splitting the out-of-band channel into three frequency bands, according to an embodiment of the present general inventive concept.

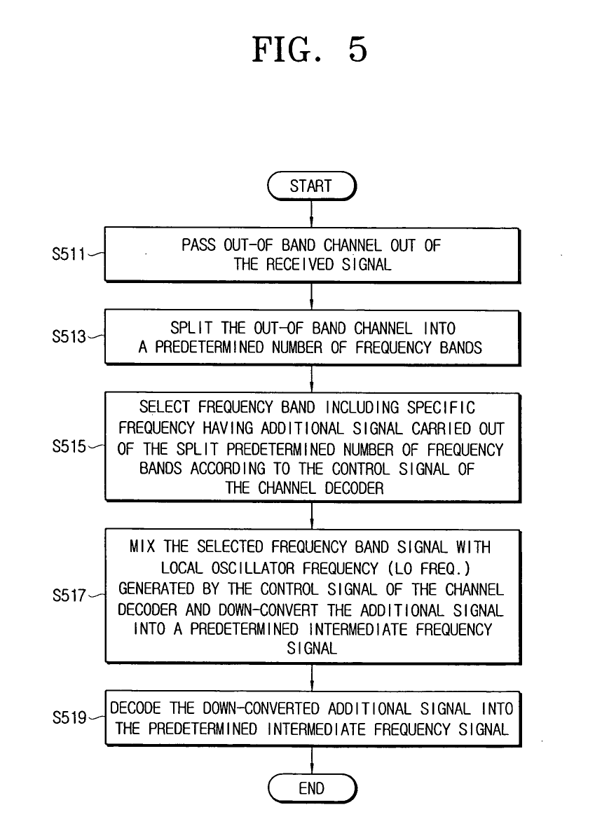

FIG. 5 is a flowchart illustrating exemplary operations to receive the additional signal in the out-of-band channel by the digital cable receiver, according to an embodiment of the present general inventive concept. With reference to FIG. 4 and FIG. 5, the description will be made on the method of receiving the additional signal in the out-of-band channel according to an embodiment of the present general inventive concept.

When the cable card 100 is mounted on the receiver, the control unit 210 can process the additional signal in the out-of-band channel in cooperation with the cable card 100 via the interface unit 170. The control unit 210 can obtain out-of-band information to process the additional signal by exchanging data with the cable card 100 via the interface unit 170. The control unit 210 can output the obtained out-of-band information to the channel decoder 190, and the channel decoder 190 can decode the out-of-band information and generate a predetermined control signal to control the operations of the band selection unit 150 and the down-converter 160. The subsequent process to receive the additional signal in the out-of-band channel that is received is described below in more detail.

The digital cable signal received from the tuner 110 passes only the out-of-band channel through the out-of-band filter 130 at operation S511. The out-of-band channel passed through the out-of-band filter 130 can be input to the band splitting unit 140 having n band filters 140-1, 140-2, . . . , 140-n. Each of the n band filters 140-1, 140-2, . . . , 140-n can pass each of the frequencies corresponding to the cut-off frequencies from operation S513. For example, if the band splitting unit 140 consists of three band filters, such as a low pass filter (LPF), a band pass filter (BPF), and a high pass filter (HPF) having the characteristics as shown in FIG. 5, the low pass filter passes only the low frequency band (L), the band pass filter passes only the frequency band (B), and the high pass filter passes only the high frequency band (H). As shown in FIG. 4, each of the cut-off frequencies of these filters can be designed so that a certain frequency band (I) is overlapped with each other, the certain frequency band (I) being at least 5 MHz.

The band selection unit 150 can select the frequency band carrying the additional signal out of the frequency bands output from each of the low pass filter, the band pass filter, and the high pass filter according to the control signal of the channel decoder 190 at operation S515. For example, if the additional signal is carried on 75.25 MHz, the band selection unit 150 selects the frequency band (L) output from the low pass filter.

The down-converter 160 can mix the signal of the frequency band (L) selected by the band selection unit 150 with the local oscillator frequency generated based on the control signal of the channel decoder 190 and can down-convert the mixed signal into a predetermined intermediate frequency signal at operation S517. For example, the channel decoder 190 provides the down-converter 160 with the control signal for down-converting the additional signal A carried on the specific frequency 75.25 MHz in the selected frequency band into a predetermined intermediate frequency signal 44 MHz, and the down-converter 160 generates, based on the control signal, a local oscillator frequency 119.25 MHz in which the difference component for the specific frequency 75.25 MHz becomes the predetermined intermediate frequency signal 44 MHz and mixes the generated local oscillator frequency with the specific frequency, thus down-converting the additional signal A in the selected frequency band (L) into the predetermined intermediate frequency signal.

The channel decoder 190 can decode the down-converted intermediate frequency signal, that is, the additional signal A in the out-of-band channel in a predetermined manner at operation S519.

The control unit 210 can control the digital cable receiver using the decoded additional signal.

As described above, it is possible to selectively pass only the frequency band carrying the additional signal out of the out-of-band channel using the information on the frequency band carrying the additional signal in the out-of-band channel and to down-convert the selected frequency band, thus eliminating the interference with other channels adjacent to the additional signal.

In an embodiment of the general inventive concept as described above, it is possible to split the out-of-band channel into a predetermined number of frequency bands, and based on the frequency band information of the additional signal included in the cable card being the security module mounted on the receiver, to select and down-convert the frequency band including the additional signal out of the split predetermined number of frequency bands.

It is also possible to improve the reception performance of the additional signal by essentially eliminating the interference with other channels adjacent to the additional signal.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A digital cable receiver on which a cable card having out-of-band information relating to an additional signal in an out-of-band channel in addition to a broadcasting signal is mounted, comprising:
an out-of-band filter to output a band channel from a received signal;
a band splitting unit to split the out-of-band channel into a predetermined number of frequency bands;
a band selection unit to select a frequency band carrying the additional signal from one of the predetermined number of frequency bands;
a down-converter to down-convert the additional signal in the selected frequency band into a predetermined intermediate frequency signal; and
a control unit to control the band selection unit and the down-converter in cooperation with the cable card.

2. The receiver as claimed in claim 1, further comprising a channel decoder to decode the received signal in a predetermined manner, wherein the channel decoder decodes the out-of-band information interfaced from the cable card, and provides the band selection unit and the down-converter with each of control signal based on the decoded out-of-band information.

3. The receiver as claimed in claim 1, wherein the band splitting unit includes a predetermined number of band filters, the cut-off frequency of each of the band filters being set so that a certain frequency band is overlapped with each other.

4. A digital cable receiver, comprising:
a band splitting unit to split an out-of-band channel into a predetermined number of frequency bands;
a band selection unit to select a particular frequency band chosen to carry an additional signal from one of the predetermined number of frequency bands; and
a down-converter to down-convert the additional signal in the particular frequency band into a predetermined intermediate frequency signal.

5. The apparatus as recited in claim 4, further comprising:
a channel decoder to decode the predetermined intermediate frequency signal.

6. The apparatus as recited in claim 5, further comprising:
a control unit to output outer band information to the channel decoder, causing the channel decoder to decode the outer band information and generate a control signal to control the band selection unit and the down-converter.

7. The apparatus as recited in claim 6, further comprising:
an interface unit outputting the outer band information to the control unit.

8. The apparatus as recited in claim 7, further comprising:
a cable card to communicate outer band information with the control unit through the interface unit.

9. An apparatus, comprising:
a band splitting unit to split an out-of-band signal into a plurality of frequency bands;
a control unit to receive out-of-band information from a cable card; and
a band selection unit to receive the out-of-band information from the control unit and to select a particular band from the plurality of frequency bands based on the received out-of-band information.

10. The apparatus as recited in claim 9, further comprising:
a down-converter to down-convert an additional signal in the particular band into a down-converted signal.

11. The apparatus as recited in claim 10, further comprising:
a channel decoder to receive the down-converted signal from the down-converter and to decode the down-converted signal.

12. A method of receiving an additional signal of a digital cable receiver on which a cable card having out-of-band information relating to an additional signal in an out-of-band channel in addition to broadcasting signal is mounted, comprising:
splitting a passed out-of-band channel into a predetermined number of frequency bands;
selecting a particular frequency band carrying the additional signal out of the split predetermined number of frequency bands; and
down-converting the additional signal in the particular frequency band into a predetermined intermediate frequency signal.

13. The method as claimed in claim 12, further comprising decoding the out-of-band information interfaced from the cable card in a predetermined manner, wherein the method controls the operations of the selecting and down-converting operations based on the decoded out-of-band information.

14. The method as claimed in claim 13, wherein, in the) splitting operations, the out-of-band channel is split into the predetermined number of frequency bands by the predetermined number of band filters, the cut-off frequency of each of the band filters being set so that a certain frequency band is overlapped with each other.

15. A signal receiving method, comprising:
splitting an out-of-band channel into a predetermined number of frequency bands;
selecting a particular frequency band carrying an additional signal from one of the predetermined number of frequency bands; and
down-converting the additional signal in the selected frequency band into a predetermined intermediate frequency signal.

16. The method as recited in claim 15, further comprising:
decoding the predetermined intermediate frequency signal.

17. The method as recited in claim 15, further comprising:
decoding the out-of-band information; and
generating a control signal controlling the selecting and the down-converting.

18. A signal receiving method, comprising:
receiving a band signal from a tuner;
splitting the received band signal into a plurality of frequency bands;
receiving out-of-band information from a cable card; and
selecting a particular band from the plurality of frequency bands based on the received outer band information.

19. The method as recited in claim 18, further comprising:
down-converting an additional signal in the particular band into a down-converted signal.

20. The method as recited in claim 19, further comprising:
decoding the down-converted signal.
